(19) United States
(12) Patent Application Publication
(10) Pub. No.: US 2008/0129710 A1
(43) Pub. Date: Jun. 5, 2008

(54) NOTEBOOK COMPUTER WITH STYLUS PEN

(75) Inventor: Szu-Wei Kuo, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/681,196

(22) Filed: Mar. 2, 2007

(30) Foreign Application Priority Data
Nov. 30, 2006 (CN) 200610201165.0

(51) Int. Cl. G06F 3/033

(52) U.S. Cl. 345/179

(57) ABSTRACT

A notebook computer includes a main body and a display unit pivotably coupled with an end portion of the main body. The main body defines a keyboard area, a handwriting area, and a receiving area having a stylus pen placed therein. The notebook computer facilitates carrying of the stylus pen.

### BACKGROUND OF THE INVENTION

1. Field of the Invention

The present invention relates to a notebook computer defining a receiving area having a stylus pen placed therein.

2. Description of Related Art

Many different input devices exist for today's computer systems. Examples include keyboards, mice, graphics tablets, touch screens, and stylus pens. These devices have become widely available for desktop and notebook computer systems.

With the continued development of computer technology, stylus pens have become more useful than in the past but need to be separately carried and stored by the person who use a notebook computer which is in convenient. Thus, a notebook computer with stylus pen carried therein is needed.

### SUMMARY OF THE INVENTION

In one preferred embodiment, a notebook computer includes a main body and a display unit pivotably coupled with an end portion of the main body. The main body defines a keyboard area, a handwriting area, and a receiving area having a stylus pen placed therein.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of one embodiment of a notebook computer with stylus pen stored in a receiving area in accordance with the present invention; and

FIG. 2 is similar to FIG. 1, but showing the stylus pen removed from the receiving area and ready for use.

### DETAILED DESCRIPTION OF THE INVENTION

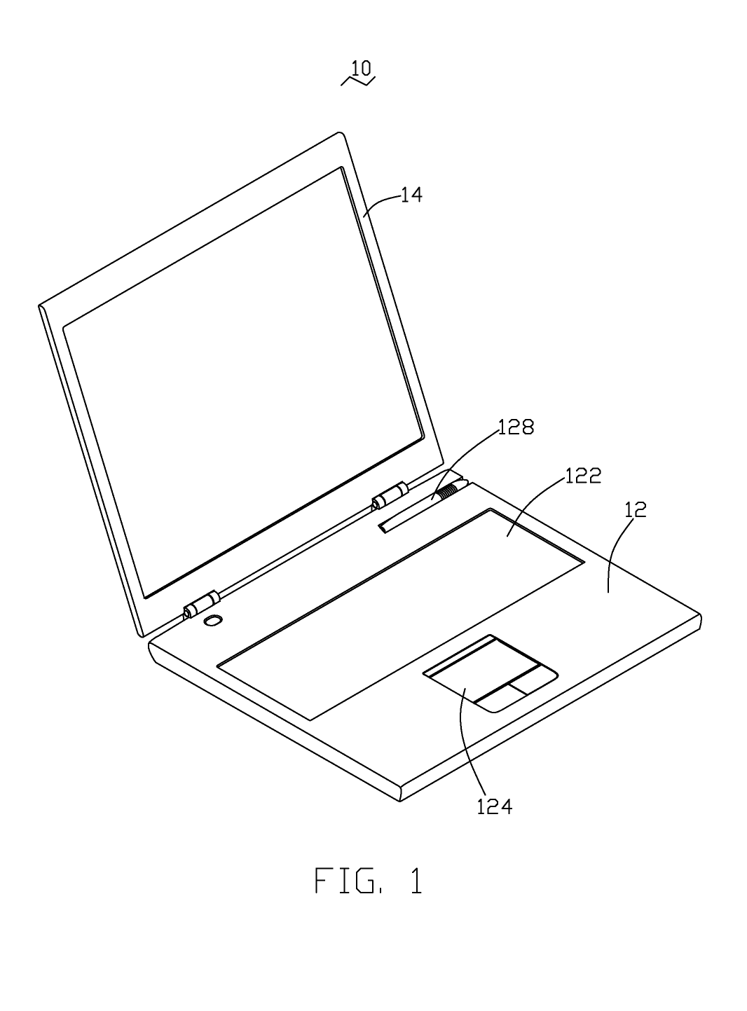

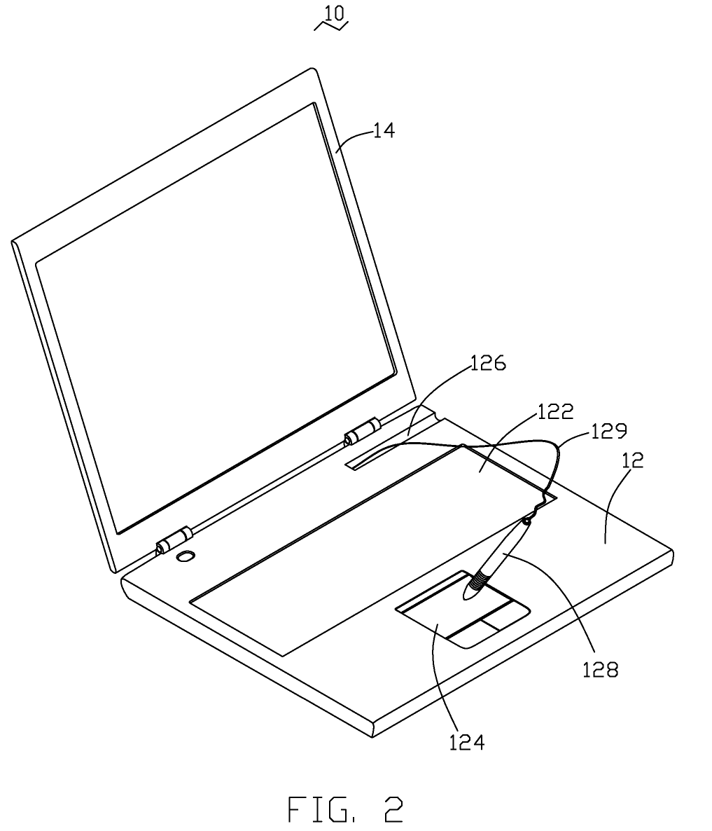

Referring to FIG. 1 and FIG. 2, a notebook computer 10 in accordance with a preferred embodiment of the present invention includes a main body 12, and a display unit 14 pivotably coupled with an end portion of the main body 12. The main body 12 defines a keyboard area 122, a handwriting area 124, and a receiving area.

In this embodiment, the receiving area is an elongated groove 126 defined in the main body 12 with a side opening defined in a side of the main body 12. A stylus pen 128 is placed in the groove 126 and can be slid out along the groove 126 via the opening. A depth of the groove 126 is slightly greater than a diameter of the stylus pen 128. A length of the groove 126 is slightly greater than a length of the stylus pen 128. An end portion of the stylus pen 128 is coupled with the main body 12 by a retractable line 129 for securing the stylus pen 128.

The notebook computer 10 carries the stylus pen 128 in the receiving area thereof, and facilitates data entry or menu interaction etc., by allowing writing with the stylus pen 128.

The groove 126 can be other shapes according to the shape of the stylus pen 128. A top opening of the groove 126 can be slightly smaller than the diameter of the stylus pen 128 for the groove 126 to snappingly receive the stylus pen 128. The side opening of the groove 126 communicates the groove 126 with outside of the main body 12 for facilitating the user to drive the stylus pen 128 to slide out of the groove 126.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A notebook computer, comprising:
a main body; and
a display unit pivotably coupled with an end portion of the main body;
wherein the main body defines a keyboard area, a handwriting area, and a receiving area having a stylus pen placed therein.

2. The notebook computer as described in claim 1, wherein the receiving area is an elongated groove defined in the main body, a depth of the groove is slightly greater than a diameter of the stylus pen and a length of the groove is slightly greater than a length of the stylus pen.

3. The notebook computer as described in claim 2, wherein an opening communicating the groove with outside of the main body is defined in a side of the main body for facilitating driving the stylus pen out of the groove via the opening.

4. The notebook computer as described in claim 2, wherein the groove is defined in a top surface of the main body faces the display unit when the display unit closes to the main body.

5. The notebook computer as described in claim 1, wherein an end portion of the stylus pen is coupled with the main body by a line one end of which is fixed to the main body.
